(19) United States
(12) Patent Application Publication
(10) Pub. No.: US 2005/0108361 A1
(43) Pub. Date: May 19, 2005

(54) Method and system for content delivery

(76) Inventors: Stewart Scott, Highlands Ranch, CO (US); Robert C. Orr, Littleton, CO (US); Jerad Harbaugh, Englewood, CO (US); James H. Comstock, Littleton, CO (US); Brett Goldberg, Englewood, CO (US); JP Goldberg, Englewood, CO (US)

Correspondence Address: Mark L. Watson;BLAKELY, SOKOLOFF, TAYLOR & ZAFMAN LLP, Seventh Floor, 12400 Wilshire Boulevard, Los Angeles, CA, 90025, US

(21) Appl. No.: 10/954,601

(22) Filed: Sep. 30, 2004

Related U.S. Application Data
(60) Provisional application No. 60/507,651, filed on Sep. 30, 2003.

(51) Int. Cl. G06F 15/173; G06F 15/16

(52) U.S. Cl. 709/217; 709/224

(57) ABSTRACT

According to one embodiment, a method is described. The method includes receiving a request from a client computer sited on a first network to access one or more media files at a data server sited on a second network, determining whether a predetermined number of media files stored at the client computer would be exceeded if the one or more media files are transmitted to the client computer, and transmitting the one or more media files from a distribution server sited on the first network to the client computer if the predetermined number of media files stored at the client computer would not be exceeded if the one or more media files are transmitted to the client computer.

This is a non-provisional patent application based on the provisional application Ser. No. 60/507,651, filed Sep. 30, 2003; and claims the priority thereof.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever.

### FIELD OF THE INVENTION

This invention relates generally to the field of network transaction services. More particularly, the invention relates to providing an end to end method and system for delivering media content, commerce, and fulfillment to devices connected via a network system.

### BACKGROUND

Currently, entertainment content providers are reluctant to utilize Internet-based distribution strategies to deliver content in the form of media files to home and business users. One major reason for such reluctance is due to the fact that current technology does not permit the practical downloading of files to users. Delivering a motion picture file to a user's computer can take in excess of an hour to download via the Internet.

However, probably the main reason that entertainment content providers are unwilling to deliver content to users via networks is because of copyright infringement concerns. Industry analysts estimate that more than 500,000 video files are pirated each day.

Moreover, consumers desire a fixed monthly fee for content while entertainment content providers currently prefer a transactional fee for each individual content item. Therefore, a content delivery system that maintains copyright protection for protected works, quickly delivers content to end users without excessive delays, and satisfies both consumer habits and entertainment content providers need for transactional fee for each individual content is desired.

### BRIEF DESCRIPTION OF THE DRAWINGS

A better understanding of the present invention can be obtained from the following detailed description in conjunction with the following drawings, in which:

FIG. 1 illustrates one embodiment of exemplary network architecture;

FIG. 2 is a block diagram of one embodiment of a data server;

FIG. 3 illustrates one embodiment of a distribution node coupled to a network;

FIG. 4 illustrates one embodiment of a client;

FIG. 5 is a flow diagram illustrating one embodiment of a user signup process;

FIG. 6 is a flow diagram illustrating one embodiment of a content download process; and

FIG. 7 is a block diagram of one embodiment of exemplary computer architecture;

### DETAILED DESCRIPTION

A content delivery system is described. In one embodiment, the content delivery system enables the electronic Rental on Demand (RoD) of entertainment content such that clients on a closed network may rent media files on demand. According to one embodiment, a user at a client computer on a closed network accesses a data server on an open network operated by a content delivery service to examine a list of motion picture content (movies) available for downloading, progressive download or streaming. The user selects one or more media files for downloading, progressive download or streaming to their network attached computer or display terminal.

Subsequently, the data server facilitates a connection between the client and a local server on the closed network that is operated by the content delivery service. Once a connection has been established and authenticated between the client and the local server, content is delivered to the client. However in one embodiment, a client is allowed to have no more than a predetermined quantity of movies “checked out” as stored on the user's computer system at any particular time. Thus, before downloading or streaming new movies to the client it is determined whether the predetermined number of movies allowed to be stored at the client would be exceeded if a download occurred.

If the download would not exceed the threshold, the selected movies are downloaded from the local server to the client. Otherwise, one or more movies and or licenses have to be deleted/and or returned prior to the availability of the newly ordered movie files.

In the following description, numerous details are set forth. It will be apparent, however, to one skilled in the art, that the present invention may be practiced without these specific details. In other instances, well-known structures and devices are shown in block diagram form, rather than in detail, in order to avoid obscuring the present invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to a system for performing the operations herein. This system may be specially constructed for the required purposes, or it may comprise a general-purpose computer selectively activated or reconfigured by a computer program stored in the computer. Such a computer program may be stored and/or transmitted in a computer readable storage medium, such as, but is not limited to, any type of read only memory (ROM); random access memory (RAM); magnetic disk storage media; optical storage media; flash memory devices; electrical, optical, acoustical or other form of propagated signals (e.g., carrier waves, infrared signals, digital signals, etc.); etc.

The displays presented herein are not inherently related to any particular computer or other systems. Various general-purpose systems may be used with programs in accordance with the teachings herein, or it may prove convenient to construct more specialized systems to perform the required methods. The required structure for a variety of these systems will be apparent from the description below. In addition, the present invention is not described with reference to any particular programming language. It will be appreciated that a variety of programming languages may be used to implement the teachings of the invention as described herein.

The instructions of the programming language(s) may be executed by one or more processing devices (e.g., processors, controllers, central processing units (CPUs), execution cores, etc.).

Elements of the present invention may also be provided as a machine-readable medium for storing the machine-executable instructions. The machine-readable medium may include, but is not limited to, floppy diskettes, optical disks, CD-ROMs, and magneto-optical disks, ROMs, RAMs, EPROMs, EEPROMs, magnet or optical cards, propagation media or other type of media/machine-readable medium suitable for storing electronic instructions. For example, the present invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

An Exemplary Network Architecture

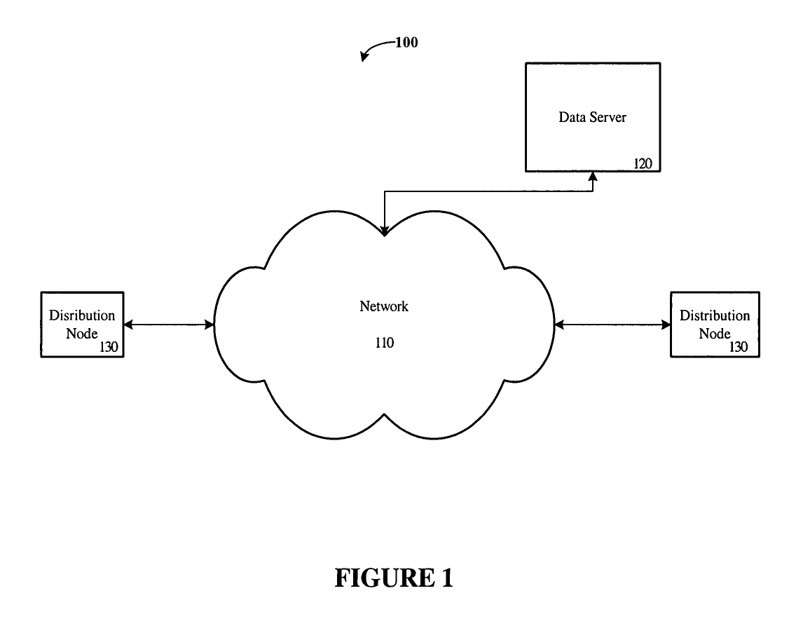

FIG. 1 is a block diagram of one embodiment of a content delivery system 100. System 100 includes network 110, a data server 120 and one or more distribution nodes 130. The teachings disclosed herein might be applied to various networks, data and document storage and archival facilities, or other types of client/server systems that have documents or other information available upon request.

According to one embodiment, server 120 and nodes 130 are coupled to network 110 and are able to respond to requests from each other via network 110. In one embodiment, the received requests are associated with the Internet (or World Wide Web (the WWW)). In such an embodiment, data server 120 and nodes 130 act as inter-networked communications systems (e.g., WWW servers). That is, clients (not shown) are directly coupled to a local area network (LAN) or wide area network (WAN) and “serve” data, such as images or other multi-media objects that they capture or create to the servers. Alternative communication channels such as wireless communication via satellite broadcast (not shown) are also contemplated within the scope of the present invention.

According to one embodiment, data server 120 and distribution node 130 may include databases for storing various types of data. The database may include, for example, specific client data (e.g., client account information and client preferences) and/or more general data. The database on server 120 and node 130 in one embodiment runs an instance of a Relational Database Management System (RDBMS), such as Microsoft™ SQL-Server, Oracle™ or the like.

According to one embodiment, data server 120 and distribution node 130 comprise a Content Distribution Network (CDN) that delivers high-quality audio and video content to clients coupled to a closed network as a part of the content delivery service. In a further embodiment, each node 130 is coupled to a university LAN. In other embodiments, node 130 could be coupled to a LAN at any location requiring entertainment services. A node 130 distributes authorized content (e.g., motion pictures, music, etc.) to students, or other authorized persons, at a university utilizing the CDN.

The CDN is a closed circuit environment using the LANs of universities to supply content facilitated by data server 120 and distributed by a node 130. In one embodiment, content is transmitted from data server 120 to the node 130 associated with a particular university. In a further embodiment, each university campus operates as a stand-alone provider. Thus, the existing bandwidth on a university LAN may be leveraged to deliver high-quality content to computer systems on a residential campus network. This minimizes external network traffic while maximizing consumer bandwidth utilization, providing a better end-user experience a higher quality of video and at faster speeds.

In one embodiment, a student, or other authorized network user, selects a media file at data server 120. In response, a node 130 associated with the campus transmits the media file to the students computer system. Node 130 is able to transmit the file much more rapidly than delays and latency associated with high-bandwidth media over the Internet. The transmission process between node 130 and a student user's computer system is monitored and managed by data server 120. Although described above with reference to university LANs, one of ordinary skill in the art will appreciate that the CDN may be implemented with any type of LAN application (e.g., corporate, community, residential, etc.).

In one embodiment, the authorized network user pays a fixed fee for a predetermined time period for content access. In a further embodiment, the fee will be part of the LAN owner's (e.g., university) charges (e.g. tuition, housing, technology, cable or telephone fees) to the user (e.g., student) and the LAN owners' access security controls will be leveraged to provide a seamless environment with other LAN owner services.

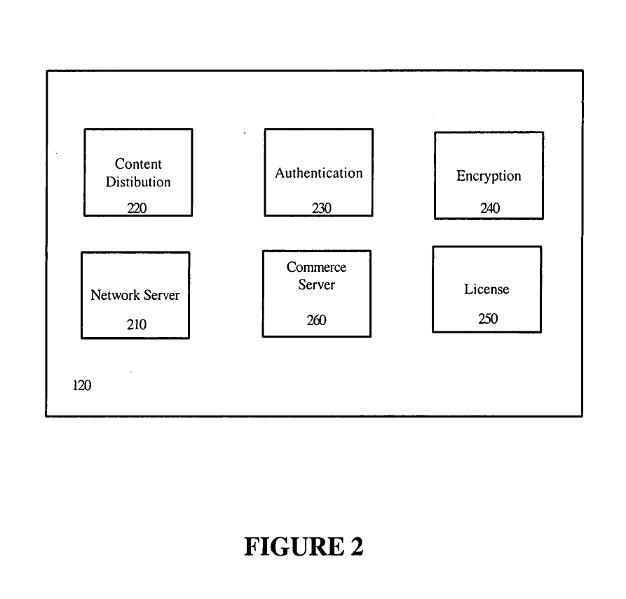

FIG. 2 is a block diagram of one embodiment of data server 120. Data server 120 includes network server 210, content distribution master 220, authentication 230, encryption 240 and license 250. Data server 120 is operated by a content service provider that facilitates the delivery of high quality media content from a distribution node 130 to client computer systems on a closed network.

Network server 210 serves the files that form Web pages to Web users via the Hypertext Transfer Protocol (hereinafter “HTTP”). Particularly, server 210 handles user accesses to data server 120 in order to sign up with the content delivery service and/or select media files for download. Although described as being served as HTTP, one of ordinary skill in the art will appreciate that other types of page formats may be implemented (e.g., secure HTTP (or HTTPS)).

Content distribution master 220 operates as a central content library. Thus, content distribution master 220 maintains media files that are distributed among various distribution nodes 130. In addition, content distribution master 220 maintains a listing of the available media files. A system user accesses this list to select one or more files to be transferred to the user.

Authentication 230 is used to authenticate a system user. In one embodiment, authentication is accomplished through a secure sign-on using a unique username/login. The sign-on procedure determines the user's role, with attendant access rights, content rights and functionality. According to one embodiment, system users are provided a client application that includes key identifiers. As a result, authentication between the client and data server 120 is automatically handled.

In one embodiment, the closed network owner provides a listing of authorized users of the network coupled to a distribution node 130. The listing includes an identification number (ID) for each of the users. Thus, when a user requests to sign up with the content delivery service, the user's ID is compared with the provided list. For instance, a university may provide a list of student IDs to data server 120.

The student IDs represent the students that are authorized to use the university's LAN. A student later signing up at data server 120 provides the ID, which is compared to the list provided by the university. Consequently, a shared authentication ID with the LAN owner provides for seamless and secure authentication. Authentication can provide the basis for a closed circuit environment.

Encryption 240 is used to encrypt and encode media files that are delivered to distribution nodes for transmission to users. In one embodiment, media files are encrypted with a level of Digital Rights Management (DRM) that prohibits the media from being viewed unless the requesting computer system is authorized by the content delivery service. The encrypted files are distributed among the nodes 130.

License 250 supervises the DRM for files stored at a client. In one embodiment, DRM licenses are issued with one or more conditions. For example, conditions include one time play, play between valid dates, play by specific clients, etc. In a further embodiment, a user may select a pre-delivered license that enables later viewing. In such an embodiment, a client need not be connected to license 250 to play the content. However, the client will have a certain period of time for viewing. Subsequently, the content will automatically be deleted and/or returned.

In yet a further embodiment, data server 120 includes a database (not shown). License 250 accesses the database to track valid licenses assigned to clients. As a result, license 250 may track and limit the number of media files stored at a client, as will be described below in greater detail.

In one embodiment, the service provider purchases a predetermined number of copies for each media file (e.g., movie) provided to system users. Data server 120 subsequently tracks how many copies that have been downloaded to users, and will not issue more copies until licenses to the users have expired, or have been deleted or returned.

Although described above as a single server, the applications described within data server 120 may be separated amongst one or more additional servers. For example, in some embodiments each application may be included within a separate server.

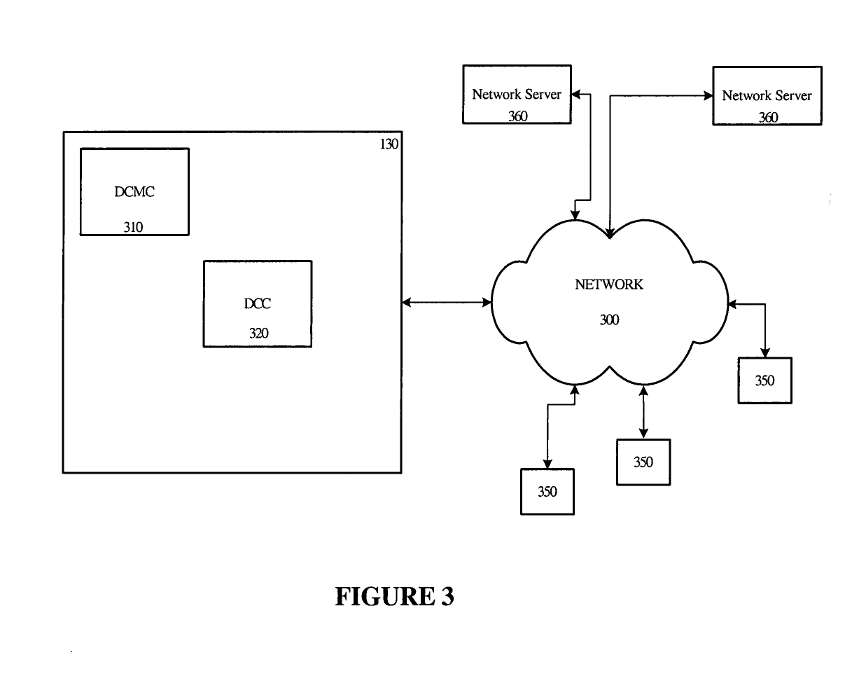

FIG. 3 illustrates one embodiment of a distribution node 130 coupled to a network 300. In one embodiment, network 300 is a LAN operated by an entity such as a university, business, community, etc. However, one of ordinary skill in the art will appreciate that other types of networks may be implemented.

Distributed node 130 includes distributed content master cache (DCMC) 310 and distributed content cache (DCC) 320. DCMC 310 securely connects between data server 120 and DCCs 320 in order to replicate content. In one embodiment, DCMC 310 is located at the primary data center associated with network 300.

DCMC 310 controls one or more DCCs 320 and manages media content. In addition, DCMC 310 imports media files into distribution node 103, and provides backup for DCCs 320. DCC 320 is a caching engine that locally stores a variety of media and web files. In one embodiment, DCC 320 delivers media files to a client 350 on request by a user at the client 350. In addition, DCC 320 locally serves graphic and other content, thus providing the content without the delays attributed to the Internet.

In one embodiment, DCC 320 supports multiple concurrent requests for content. In a further embodiment, DCC 320 supports various media and file types (e.g., MPEG-1, MPEG-2, MP3, Windows Media, Real Media, Apple Quick Time, GIF, Shockwave Flash, JPEG, HTML, SMIL, etc.). Although described above as a single server, the applications described within node 130 may be separated amongst one or more additional servers. For example, in some embodiments each application may be included within a separate server.

As shown in FIG. 3, clients 350 and network servers 360 are coupled to network 300, along with node 130. Network servers 360 are servers owned and operated by the owner of network 300. For example, one or more of the network servers 360 may be web servers. Clients 350 may interact with and receive feedback from servers (e.g., server 120, servers 360 and node 130) using various different communication devices and/or protocols.

According to one embodiment, a client 350 connects to servers via client software. The client software may include a browser application such as Netscape Navigator™ or Microsoft Internet Explorer™ on which the client communicates to the servers and/or the data center via HTTP.

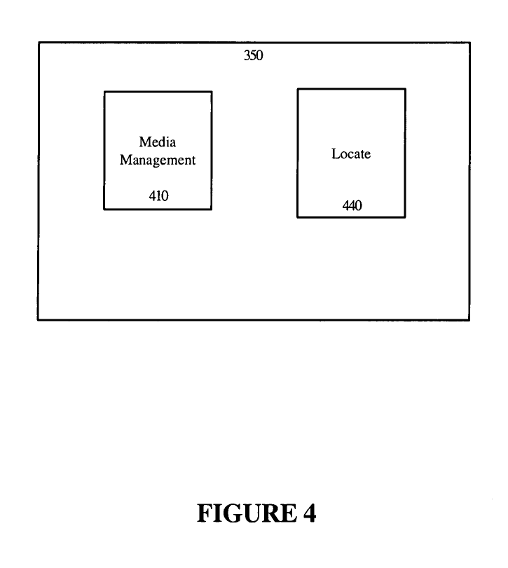

According to a further embodiment, client software is provided to a client 350 via data server 350. FIG. 4 illustrates one embodiment of a client 350. Client 350 includes media management 410, locate module 440. Media management 410 manages the media files at client 350 provided by DCC 320.

According to one embodiment, media management 410 enables a predetermined amount of media files to be delivered by the content delivery system to be stored at any one time. For example, a user may pay a rental fee (or subscription) to the service provider and gain access to six media files at any time. The user may access these files as often as the user desires. However, prior to downloading additional files, the user must delete or return one or more of the previously downloaded files. Thus, if the user wants to receive three new media files, three existing files must be deleted or returned.

In other embodiments, it is only necessary for the license of a media file to expire prior to downloading additional files. Consequently, prior to downloading additional files, license 250 at data server 120 confirms whether licenses have expired on files at a client 350 prior to downloading additional files.

In another embodiment, the user returns the license to license 250 prior to additional files being downloaded. In such an embodiment, media management 410 in conjunction with license 250 delete the applicable media files. Further, additional files may be downloaded if both the licenses and media files have been returned to data server 120.

In a further embodiment, 310 at node 130 facilitates the deletion or return of media files by media management 410. In this embodiment, a user is prompted that the download of new files cannot proceed until a current file at client 350 is deleted or returned. the user is then provided a list of the files currently stored at client 350 and given an option to have one or more of the files deleted or returned.

Once the users select the files to be deleted, media management 420 deletes the files. Subsequently, new files may be downloaded. In another embodiment, media management 420 automatically deletes or returns media files stored at a client after a predetermined time. For instance, files may be automatically deleted 24-72 hours after the particular files have been received or opened at the client 350.

Locate module 440 enables client 350 locate the closest DCC 320 on network 300. For instance, in some embodiments where network 300 is a widely distributed network, two or more DCCs 320 are provided. Locate module 440 transmits request signals over network 300 that are received by DCCs 320 and returned to locate module 440.

In response to receiving the signal from the DCCs, locate module 440 determines which DCC has the best performance for the particular client 350. Accordingly, the client 350 requests content from the particular DCC that provides the best performance. In one embodiment, this process occurs each time a download is requested at a client 350 to enable the retrieval of content from the closest/fastest DCC. The implementation of locate module 440 obviates the necessity of configuring DCCs for specific networks 300 since there is no need to know about the network.

System Operation

Although the present content delivery system will be discussed with reference to various illustrated examples, these examples should not be read to limit the broader spirit and scope of the present invention. For example, the examples presented herein describe Internet-based apparatus and methods, which are but one embodiment of the present invention. The general concepts and reach of the present invention are much broader and may extend to any computer-based or network-based event system.

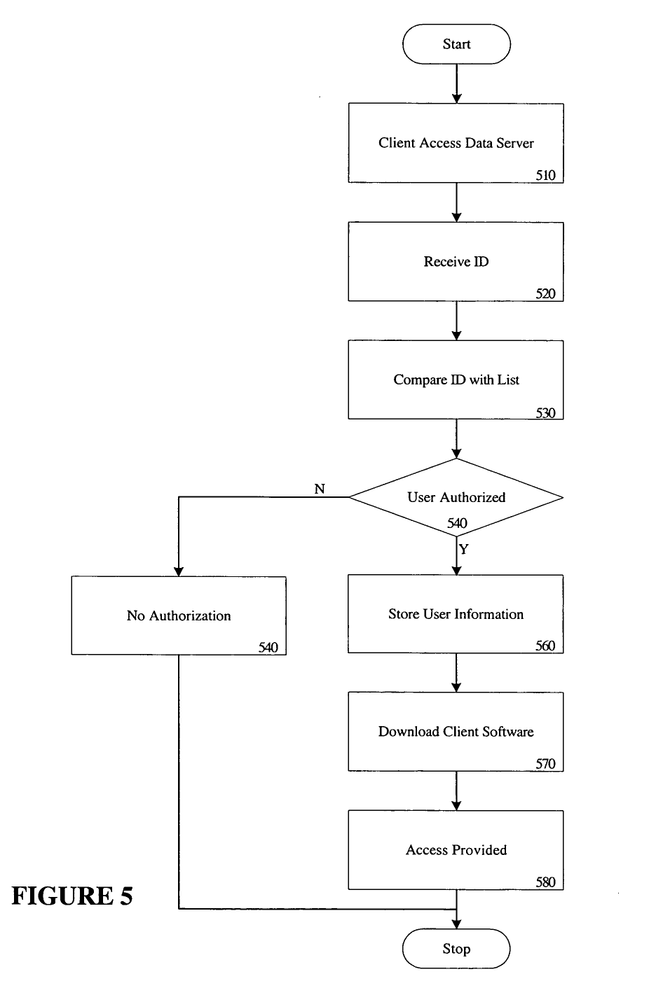

FIG. 5 is a flow diagram illustrating one embodiment of a user signup process at data server 120. At processing block 510, a user at a client 350 accesses data server 120 via network server 210. While at the site provided by the content service provider, the user selects a hypertext link indicating an interest in signing up for the content delivery service.

At processing block 520, authentication 230 receives a user ID entered into the page by the user or media management 410 at client 350. As discussed above data server 120 stores a list of IDs provided by the network 300 owner. At processing block 530, the provided user ID is compared to the list of IDs received from owners of various networks 300. At decision block 540 it is determined whether the user is authorized to use the service. The user has authorization if the user provided ID matches an ID stored at data server. One embodiment integrates a closed-circuit network provider's (such as a university) authentication systems and processes to provide further security.

If the user does not have authorization, the user is provided a message that authorization is not possible, processing block 550. In one embodiment, the user is provided information as to why authorization is not permitted, and the possible ways in which authorization may be obtained. This authorization also acts as a deterrent to piracy since unauthorized users are unable to open content. Further, by populating file sharing services with large quantities of materials that cannot be opened, significant inconvenience is presented to a non-authorized participant.

If the user's ID is found, the user is prompted to provide various information (e.g., name, address, sec, etc.), processing block 560. At processing block 570, client software is downloaded to the client 350. At processing block 580, the user is granted access to the service and is authorized to download content.

In another embodiment, the network 300 owner first authenticates a user. In such an embodiment, a secure encrypted cookie is transmitted to authentication 230. As a result, authentication 230 verifies the authentication of the user, enabling user access to the system. In yet another embodiment, the owner of network 300 provides authentication 230 at server 120.

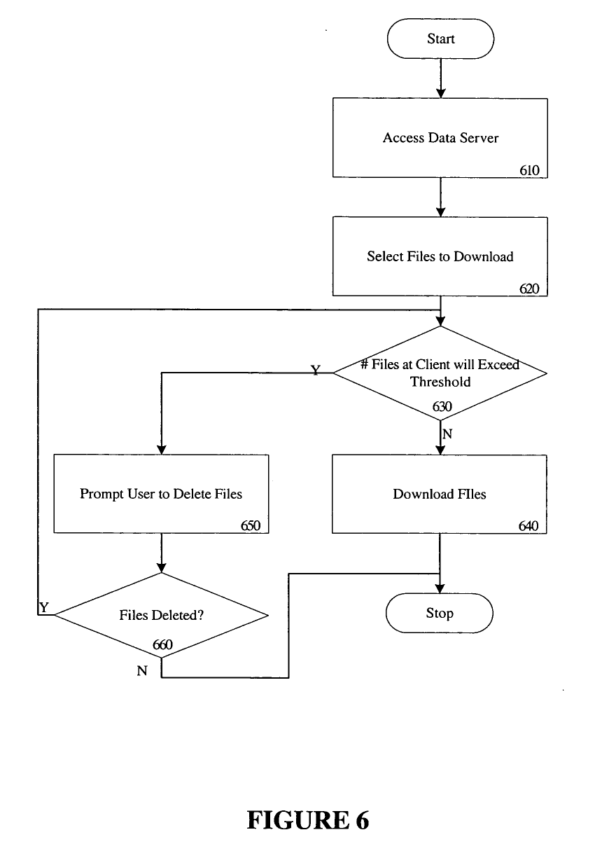

FIG. 6 is a flow diagram illustrating one embodiment of a content download process. At processing block 610, a user at a client 315 accesses data server 120 to examine the list of media files provided by the content delivery service. As discussed above, the media files may include motion picture content that the user may download for viewing.

At processing block 620, the user selects one or more media files for downloading. Subsequently, data server 120 facilitates a connection between the client 135 and a DCMC 310 on the network 300 on which client 315 is coupled. As previously described, locate module 440 within client 350 may perform a search for the nearest node 130 on network 300.

Once the client 315 has contacted a node 130, content manager 410 in conjunction with media management 410 at client 315, determines whether the predetermined number of media files allowed to be stored at client 315 would be exceeded if a download occurred, decision block 630. If the download would not exceed the threshold, the selected movie files are downloaded from DCC 320 to client 315, processing block 640.

If, however, the download would exceed the threshold, a message is generated indicating to the user that the selected files will not be downloaded since the download would exceed the permissible quantity of files stored at client 315, processing block 650. Subsequently, the user is prompted to delete or return one or more files in order to facilitate the transmission of the newly selected files. also, media management 410 may automatically delete or return files chosen by the user for deletion.

At this point the user has a decision as to whether to delete or return one or more files so that the user may receive the newly selected content, or the user may stop the process. At decision block 660, it is determined whether the user has deleted one or more media files. if files have been deleted or returned, control is returned to decision block 630 where it is again determined whether the predetermined number of media files allowed to be stored at client 315 would be exceeded if a download occurred.

As described above, new files are not downloaded until licenses, as recorded by license 250 at data server 120, have expired or have been expended. In another embodiment, the central database at data server 120 is updated whenever license 250 verifies that all copies of a file has been deleted/returned or inactivated.

An Exemplary Computer Architecture

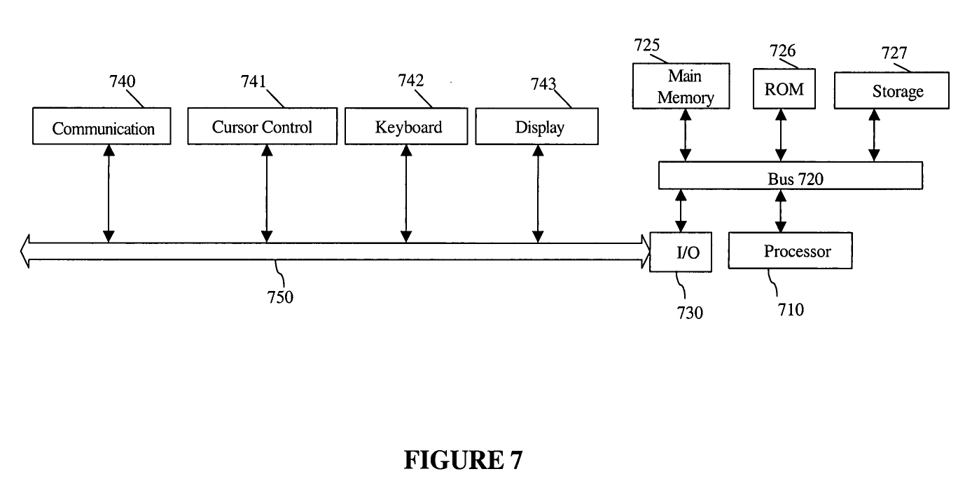

Having described an exemplary network architecture that employs various elements of the present invention, a computer system 700 representing exemplary clients 135 and/or servers 120 and servers at node 130 in which elements of the present invention may be implemented will now be described with reference to FIG. 7.

One embodiment of computer system 700 includes a system bus 720 for communicating information, and a processor 710 coupled to bus 720 for processing information. Computer system 700 further comprises a random access memory (RAM) or other dynamic storage device 725 (referred to herein as main memory), coupled to bus 720 for storing information and instructions to be executed by processor 710. Main memory 725 also may be used for storing temporary variables or other intermediate information during execution of instructions by processor 710. Computer system 700 also may include a read only memory (ROM) and/or other static storage device 726 coupled to bus 720 for storing static information and instructions used by processor 710.

A data storage device 727 such as a magnetic disk or optical disc and its corresponding drive may also be coupled to computer system 700 for storing information and instructions. Computer system 700 can also be coupled to a second I/O bus 750 via an I/O interface 730. A plurality of I/O devices may be coupled to I/O bus 750, including a display device 743, an input device (e.g., an alphanumeric input device 742 and/or a cursor control device 741). For example, video news clips and related information may be presented to the user on the display device 743. Moreover, a printer 744 may be included in computer 700 to provide hard copies of documents.

The communication device 740 is for accessing other computers (servers or clients) via network 110 or 300. The communication device 740 may comprise a modem, a network interface card, or other well-known interface device, such as those used for coupling to Ethernet, token ring, or other types of networks.

The above-described content delivery system provides an interactive service that enables users of closed circuit high-speed networks to legally download high-quality audio/video content for rental purposes. Thus, users at client computers may electronically rent entertainment on demand (RoD). Since the content is stored locally on the closed network, the content may be quickly downloaded without the delays attributed to open networks such as the Internet. In addition, the bandwidth of the consumer is increased, and both the quality of content viewing and service is much enhanced.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims which in themselves recite only those features regarded as the invention.

1. A method comprising:
receiving a request from a client computer sited on a first network to access one or more media files at a data server sited on a second network;
determining whether a predetermined number of media files stored at the client computer would be exceeded if the one or more media files are transmitted to the client computer; and
transmitting the one or more media files from a distribution server sited on the first network to the client computer if the predetermined number of media files stored at the client computer would not be exceeded if the one or more media files are transmitted to the client computer.

2. The method of claim 1 further comprising:
the data server facilitating the deletion of at least one media file stored at the client computer if the predetermined number of media files stored at the client computer would be exceeded if the one or more media files are transmitted to the client computer; and
transmitting the one or more media files from the distribution server.

3. The method of claim 2 wherein the deletion of at least one media file comprises removing the at least one media file from the client computer.

4. The method of claim 2 wherein the deletion of at least one media file comprises returning the at least one media file to the distribution server.

5. The method of claim 2 wherein the deletion of at least one media file comprises causing a license for the at least one media file to expire.

6. The method of claim 1 wherein the second network comprises a second distribution server.

7. The method of claim 6 wherein the first and second distribution servers receive a location signal from the client computer, the location signal to determine the distribution server that will provide the fastest transmission of the one or more media files.

8. The method of claim 1 further comprising:
the client computer accessing the data server to search a list comprising a plurality of media files; and
the client computer selecting the one or more media files from the distribution server.

9. The method of claim 1 wherein the first network comprises a local area network (LAN) and the second network comprises the public Internet.

10. A content distribution system comprising:
a first communication medium;
a data server, coupled to the first communication medium, to receive requests to access one or more media files;
a second communication medium;
a distribution server, coupled to the second communication medium, to distribute the one or more media files; and
a client computer, coupled to the second communication medium, to receive the one or more media files from the distribution server via the second transmission medium if a predetermined number of media files stored at the client computer would not be exceeded if the one or more media files are transmitted to the client computer

11. The system of claim 10 wherein the data server facilitates the deletion of at least one media file stored at the client computer if the predetermined number of media files stored at the client computer would be exceeded if the one or more media files are transmitted to the client computer.

12. The system of claim 11 wherein the deletion of at least one media file comprises removing the at least one media file from the client computer.

13. The system of claim 11 wherein the deletion of at least one media file comprises returning the at least one media file to the distribution server.

14. The system of claim 11 wherein the deletion of at least one media file comprises causing a license for the at least one media file to expire.

15. The system of claim 10 further comprising a second distribution server coupled to the second transmission medium.

16. The system of claim 15 wherein the client computer comprises a locate component to determine which of the first and second distribution servers provide a faster data download.

17. The system of claim 16 wherein the locate component transmits a locate signal to the first and second distribution servers, the location signal to determine the distribution server that will provide the fastest transmission of the one or more media files.

18. The system of claim 17 wherein the data server comprises a content distribution component to maintain a plurality of media files.

19. The system of claim 18 wherein the content distribution component maintains a listing of the plurality of media files.

20. The system of claim 10 wherein the data server comprises an authentication component to authenticate the client computer.

21. The system of claim 20 wherein the authentication component authenticates the client computer by searching a list of identifiers provided by the operator of the second transmission medium to find an identifier provided by the client computer.

22. The system of claim 18 wherein the data server comprises an encryption component to encrypt and encode the plurality of media files.

23. The system of claim 12 wherein the data server further comprises a license component to manage the conditions in which the plurality of media files are used.

24. The system of claim 10 wherein the distribution server comprises a content cache to transmit the one or more media files to the client computer.

25. The system of claim 24 wherein the distribution server comprises a master cache to connect with the data server and replicate a plurality of media files.

26. The method of claim 10 wherein the first communication medium comprises the public Internet and the second communication medium comprises a local area network (LAN).
